(19) United States
(12) Patent Application Publication
(10) Pub. No.: US 2007/0135983 A1
(43) Pub. Date: Jun. 14, 2007

(54) Initialization process for an occupant classification initialization

(75) Inventors: Donald M. McDonald, Howell, MI (US); Mohannad Murad, Troy, MI (US)

Correspondence Address: FOLEY AND LARDNER LLP;SUITE 500, 3000 K STREET NW, WASHINGTON, DC, 20007, US

(73) Assignee: AUTOMOTIVE SYSTEMS LABORATORY, INC.

(21) Appl. No.: 11/298,664

(22) Filed: Dec. 12, 2005

(51) Int. Cl. B60R 22/00

(52) U.S. Cl. 701/45; 280/735; 180/273

(57) ABSTRACT

A system for initializing a module is provided wherein the system includes components associated with the module that are assembled separately. The system includes a sensor, a datum, a data reader, and a memory. The sensor and the datum are mounted on an item. The datum is associated with the sensor and is captured on the item in the form of a machine-readable code. The data reader reads the datum and communicates the datum to the memory that stores the datum. The stored datum is used in a module of a product that includes the item. In an exemplary embodiment, the product is a vehicle, the item is a seat, and the module controls a safety system for the vehicle. The safety system includes load sensors mounted in the seat to measure a weight of a seat occupant. The weight of the seat occupant is used to control the deployment of the vehicle safety systems such as an air bag or a seat belt pretensioner.

### FIELD OF THE INVENTION

The subject of the disclosure relates generally to a vehicle safety system. More specifically, the disclosure relates to an initialization process for an occupant classification system that measures a weight of a seat occupant.

### BACKGROUND OF THE INVENTION

A vehicle generally contains automatic safety restraint devices activated during a vehicle crash to reduce occupant injury. Examples of such automatic safety restraint devices include air bags, seat belt pretensioners, and deployable knee bolsters. Generally, it is preferable to activate automatic safety restraint devices only when needed to mitigate injury due to the expense in replacing the associated components of the safety restraint system. It also is important to control the deployment force of airbags and the pretension of seatbelts based on the size of the seat occupant to reduce the potential for such activations to harm occupants. For example, when an adult is seated on the vehicle seat, the airbag can be deployed in a normal manner; however, if a small child is seated on the seat, the airbag either should not be deployed or should be deployed with a lower deployment force. To control the airbag deployment and/or seat belt pretension, information related to the weight and/or the position of the seat occupant is determined. The weight and position information can be used to classify the seat occupant into various groups, e.g., adult, child, infant, occupant leaning forward, etc., to control the usage of the safety restraint devices. For example, the amount of gas to be introduced into the airbag, an airbag inflating speed, or a pre-tension of the seat belt may be adjusted according to the classification of the seat occupant. To achieve the classification, sensors are used to measure the weight of the seat occupant.

Exemplary sensors include load sensors arranged near the four corners at the bottom of a seat. Load sensor include data associated with their correct operation. For example, a strain gauge used as a load sensor includes an offset voltage that is generated when the load is zero. A different offset voltage may be associated with each strain gauge. As a result, to accurately measure the load, it is generally necessary to compensate for the offset voltages. The offset voltage for each sensor is stored during a calibration process for use in determining a seat occupant weight and classifying a seat occupant.

Using current occupant classification systems, the occupant classification module is attached to the seat and calibrated at the seat manufacturing plant prior to installation of the seat into the vehicle. It is desirable, however, to integrate the occupant classification module with the vehicle safety system control module that is not attached to the vehicle seat, and thus, is not available at the seat manufacturing plant for calibration of the sensors. As an alternative, calibration of the sensors can be performed after installing the seat in the vehicle, but this process is more difficult due to the reduced accessibility of the seat. Thus, what is needed is a process for calibrating the sensors prior to installation of the seat in the vehicle and initializing an occupant classification module that is not attached to the seat.

### SUMMARY OF THE INVENTION

An exemplary embodiment of the invention provides a system and a method for initializing an occupant classification module, wherein components associated with the occupant classification module are assembled separately. The sensors associated with the occupant classification module are mounted to a vehicle seat and calibrated. Because the occupant classification module is separate from the vehicle seat, the calibration data is encoded and placed on the seat in machine-readable form. For example, the calibration data is encoded using a bar code. When installing the seat in the vehicle, the calibration data is read using a data reader and stored to a memory accessible by the occupant classification module included as part of a vehicle safety system control module thereby initializing the occupant classification module.

The system includes, but is not limited to, a sensor, a datum, a data reader, and a memory. The sensor and the datum are mounted on an item. The datum is associated with the sensor and is captured on the item in the form of a machine-readable code. The data reader reads the datum and communicates the datum to the memory that stores the datum. The stored datum is used in a module of a product that includes the item.

Another exemplary embodiment of the invention comprises a method of initializing an occupant classification module. The method includes, but is not limited to, receiving a datum from a data reader, wherein the datum is read from a location on an item and is associated with a sensor mounted on the item and storing the received datum in a memory. The stored datum is used in a module of a product that includes the item.

In an exemplary embodiment, the product is a vehicle, the item is a seat, and the module controls a safety system for the vehicle. The safety system includes load sensors mounted in the seat to measure a weight of a seat occupant. The weight of the seat occupant is used to control the deployment of the vehicle safety systems such as an air bag or a seat belt pretensioner.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals will denote like elements.

FIG. 1 depicts a layout of a vehicle safety system in accordance with an exemplary embodiment.

FIG. 2 is a schematic view of a seat indicating a mounting arrangement for load sensors in accordance with an exemplary embodiment.

FIG. 3 is a schematic view of deformable members indicating the mounting arrangement of the load sensors in accordance with an exemplary embodiment.

FIG. 4 is a schematic view of a seat occupant classification system in accordance with an exemplary embodiment.

FIG. 5 is a block diagram illustrating a calibration process for the seat occupant classification system in accordance with an exemplary embodiment.

FIG. 6 is a block diagram illustrating components of an initialization process for the seat occupant classification system in accordance with an exemplary embodiment.

FIG. 7 is a block diagram illustrating the initialization process for the seat occupant classification system in accordance with an exemplary embodiment.

### DETAILED DESCRIPTION OF THE EXEMPLARY EMBODIMENTS

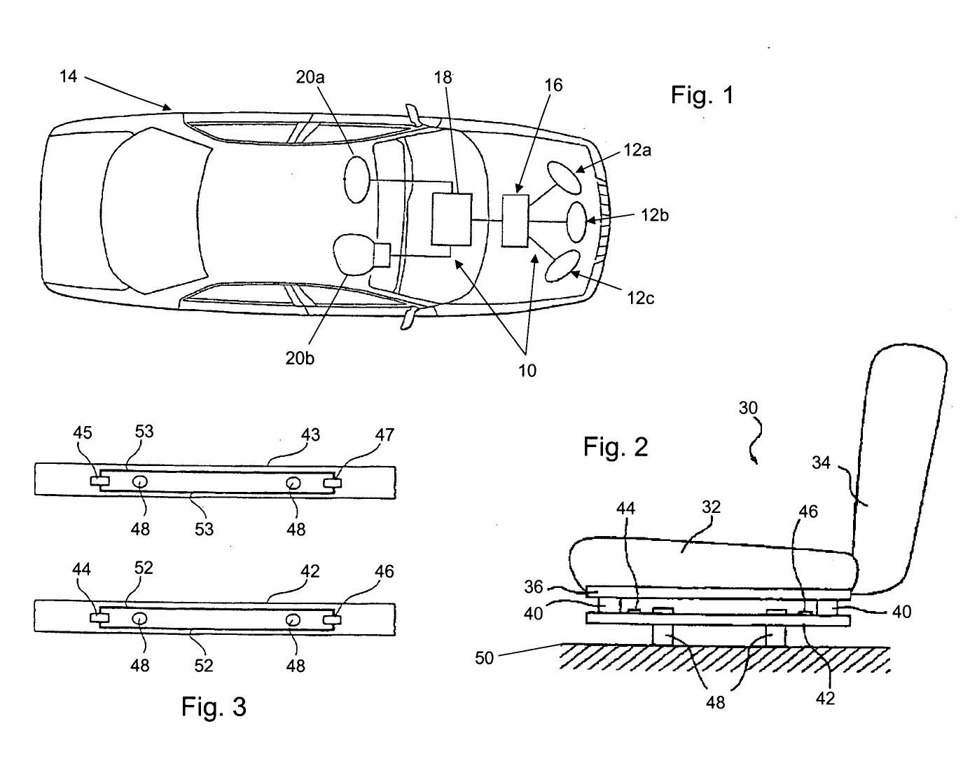

With reference to FIG. 1, an exemplary layout of a vehicle safety system 10 is shown. Vehicle safety system 10 may include one or more sensor 12a, 12b, 12c mounted near the front of a vehicle 14 and connected to a sensor processor 16. Sensor processor 16 couples to a control module 18. Control module 18 controls the operation of the vehicle safety system 10. Control module 18 may be implemented in firmware, software, hardware, or any combination thereof. Control module 18 couples to one or more safety restraint device. Control module 18 includes an occupant classification system that utilizes a weight determination module. The weight determination module determines the weight of an occupant of a seat in the vehicle 14. The weight determination module may be implemented in firmware, software, hardware, or any combination thereof. In an exemplary embodiment, the occupant classification system is integrated with the control module 18. Exemplary safety restraint devices include frontal air bag systems 20a, 20b. Control module 18 triggers an inflation of the air bag(s) when a collision is detected, for example using the one or more sensor 12a, 12b, 12c. Control module 18 may couple to other vehicle systems including the steering and braking systems as well as to other safety restraint devices such as a seat belt pretensioner, a deployable knee bolster, a side impact air bag, etc.

Generally, it is preferable to activate safety restraint devices only when needed to mitigate injury due to the expense in replacing the associated components of the safety restraint system and due to the potential for such activations to harm occupants. As a result, it is important to control the deployment force of airbags and the pretension of seatbelts based on the size of the seat occupant. To control the airbag deployment and/or seat belt pretension, information related to the weight and/or the position of the seat occupant is determined. The weight and position information can be used to classify the seat occupant into various groups, e.g., adult, child, infant, occupant leaning forward, etc., to control the usage of the safety restraint devices.

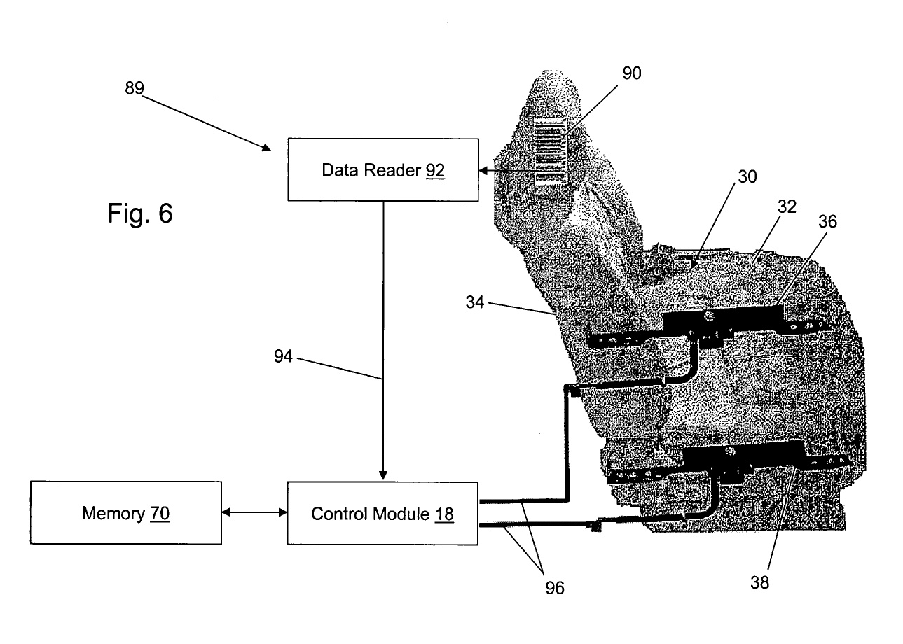

With reference to FIG. 2, sensors mounted in a seat 30 of the vehicle are used to measure the weight of the seat occupant, if any. The seat 30 may include a seat bottom 32, a seat back 34, a first seat rail 36, and a second seat rail 38 (shown in FIG. 6). The seat back 34 extends in a generally vertical direction from an edge of the seat bottom 32 that is generally horizontal and includes a bottom seat cushion on which the seat occupant sits. Seat bottom 32 includes a first side on which the seat occupant sits and a second side opposite the first side. First seat rail 36 mounts near a first edge of the second side of the seat bottom 32. Second seat rail 38 mounts near a second edge of the second side of the seat bottom 32. The second edge is opposite the first edge. Mounted to the first seat rail 36 on a side opposite the seat bottom 32 are seat legs 40. As used in this disclosure, the term “mount” includes join, unite, connect, associate, insert, hang, hold, affix, attach, fasten, bind, paste, secure, bolt, screw, rivet, solder, weld, and other like terms. A deformable member 42 mounts to the seat legs 40 opposite the first seat rail 36. The seat 30 is supported by the deformable member 42 which mounts to the floor of the vehicle 14, for example, using brackets 48 that mount to and extend up from a floor 50 of the vehicle 14.

With reference to FIG. 3, load sensors 44, 46 and wiring 52 are formed on the surface of the deformable member 42. Second seat rail 38 similarly includes seat legs 40, a second deformable member 43, load sensors 45, 47, and wiring 53. Load on the seat bottom 30 is transmitted to the deformable members 42, 43 through the seat legs 40. In response, the deformable members 42, 43 bend with brackets 48 acting as the support points and with seat legs 40 acting as deforming points. Load sensors 44, 45, 46, 47 detect the deformation due to the bending. The deformable members 42, 43 mounted to the first and second seat rails 36, 38, respectively are disposed on opposite sides of the seat bottom 32 so that a load applied on a left portion of the seat bottom 32 and a load applied on a right portion of the seat bottom 32 can be separately detected using the load sensors on each deformable member. Similarly, the load sensors 44, 46 are mounted on opposite sides of a center point of the deformable member 42, and the load sensors 45, 47 are mounted on opposite sides of a center point of the deformable member 43 so that a load applied on a front portion of the seat bottom 32 and a load applied on a rear portion of the seat bottom 32 can be separately detected using the load sensors 44, 45, 46, 47. Load sensors 44, 46, and 45, 47 may be formed on the deformable members 42, 43, respectively, between the mounting points of the seat legs 40 and the brackets 48.

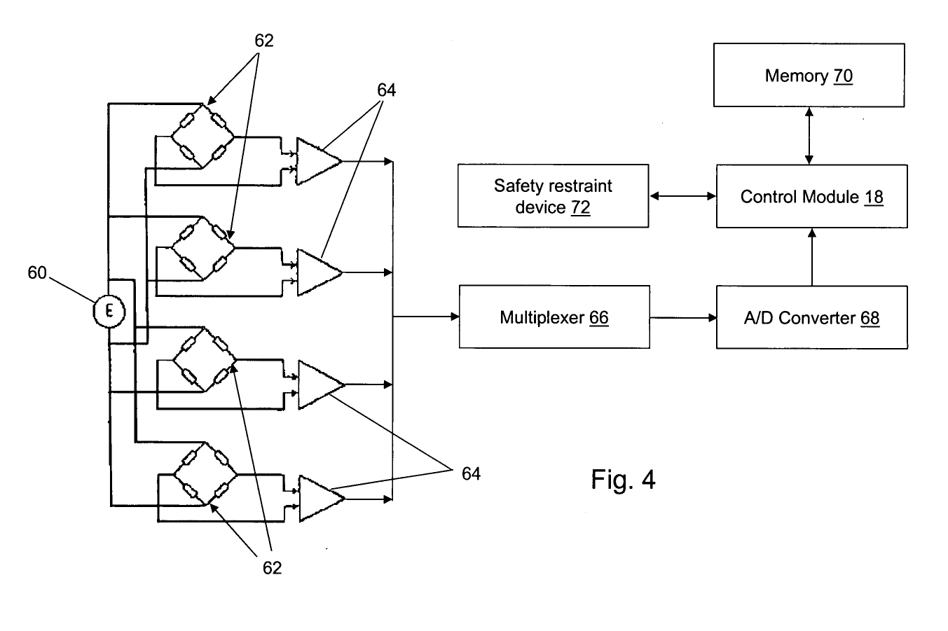

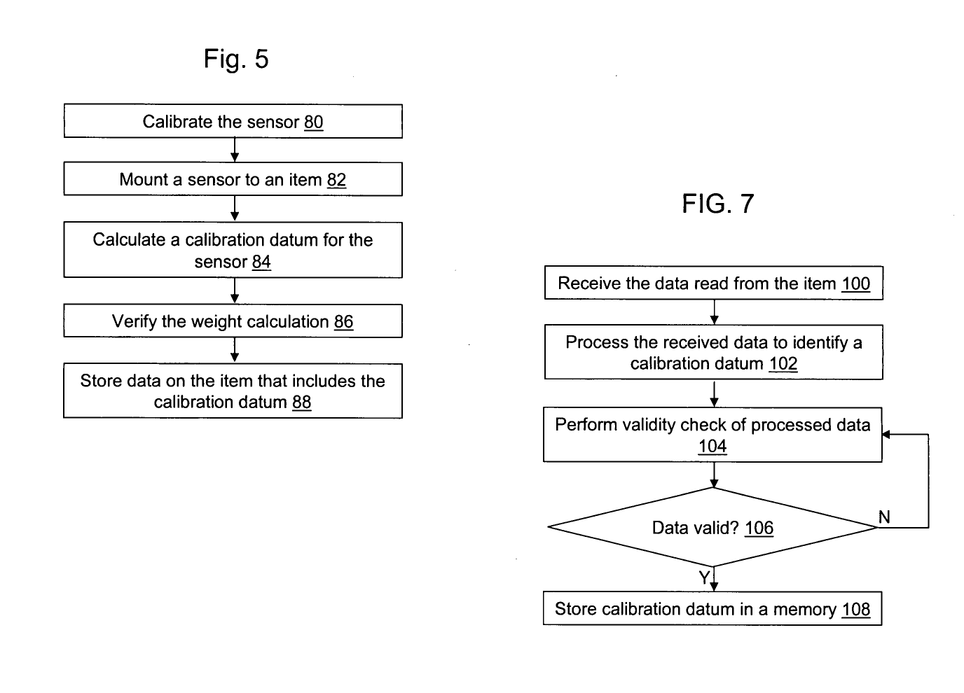

Exemplary load sensors 44, 45, 46, 47 include strain gauges arranged near the four corners of the bottom of the seat 30. Associated with each strain gauge is an offset voltage that is generated when the load is zero. Due to the unique characteristics of each strain gauge, a different offset voltage may be associated with each strain gauge. To accurately measure the load, it is preferable to compensate for the different offset voltages for each strain gauge. Additionally, the load measured by the load sensors 44, 45, 46, 47 is the sum of the weight of the seat occupant and the weight of the seat. Therefore, to measure the weight of the seat occupant, the weight of the seat must be subtracted from the total weight. To perform this calculation, the control module 18 stores an offset correction for each load sensor in a memory 70 (see FIGS. 4 and 5).

With reference to FIG. 4, a voltage is applied to the load sensors 44, 45, 46, 47 from a power source 60. In an exemplary embodiment, when a load is applied to the load sensors 44, 45, 46, 47, the resistance values of resistor elements forming bridges 62 are changed so that the balance among the bridges is also changed, generating a voltage from each load sensor. The voltages are amplified by differential amplifiers 64, input to a multiplexer 66, and converted to digital signals using an analog-to-digital (A/D) converter 68. The digital signals are received at the control module 18. The control module converts the received signals into load values. The seat occupant weight is determined by including the effect of the offset correction, stored in memory 70, on the load value determined for each load sensor. Using the determined seat occupant weight, deployment of a safety restraint device 72 can be controlled.

In assembling the vehicle 14, various system components may be manufactured at different locations and shipped to the vehicle assembly plant. For example, the seat 30 generally is manufactured at a seat manufacturing plant and shipped to the vehicle assembly plant. Before shipment of the seat 30, a calibration process is performed as shown with reference to FIG. 5. In an operation 80, a measuring circuit is connected to the load sensors 44, 45, 46, 47 without any load on the load sensors to calculate the offset voltage. In an operation 82, the load sensors 44, 45, 46, 47 are mounted to an item. In the exemplary embodiment, the load sensors 44, 45, 46, 47 formed on the deformable members 42, 43 are mounted to the seat 30. The seat 30 may be vibrated to remove any hysteresis. A load corresponding to the weight of the seat 30 is applied to the deformable members 42, 43 when the deformable members 42, 43 are mounted on the seat 30. In an operation 84, a calibration datum is calculated for each load sensor. The load sensors 44, 45, 46, 47 are connected to a measuring circuit, and the load is detected by the load sensors so that information relating to the seat weight can be determined. Such a process is known as a zero weight offset test by those skilled in the art. The zero weight offset test defines the load on the load sensors due only to the weight of the seat 30. The offset correction for each load sensor is calculated and may include the offset voltage and/or a zero weight offset. The offset correction may be in the form of a voltage, a weight, a load, etc. In an exemplary embodiment, the offset correction is a calibration datum.

In an operation 86, the calculation of the weight of a seat occupant is verified. After determination of the offset correction, an object having a known weight is placed on the seat 30, and the weight of the object is calculated. The calculated weight is compared with the known weight to verify that the determination of the weight is correct. In an operation 88, the calibration datum is stored on the item. In an exemplary embodiment, the calibration datum is encoded in a bar code 90 placed on the seat 30 as shown with reference to FIG. 6. As known to those skilled in the art, any number of different methods can be used to store the calibration datum on the seat 30. For example, the data can be encoded using letters, bar codes, magnetic strips, radio frequency identification (RFID) tags, etc. In an exemplary embodiment, the data includes a serial number for each seat rail and an offset weight for each load sensor.

As known to those skilled in the art, the calibration datum may include other parameters associated with the sensor operation. For example, the calibration datum may include a sensitivity calibration that defines the sensitivity of the load sensors 44, 45, 46, 47. The sensitivity may differ for each load sensor according to a number of parameters such as the method of fixation of the sensors.

After completion of the calibration and verification process, the seat 30 may be delivered to the vehicle assembly plant. With reference to FIG. 6, components of an initialization system 89 for the weight determination module of the occupant classification system are shown. The initialization system 89 includes a data reader 92, the control module 18, and the memory 70. Exemplary data readers include a bar code reader, a magnetic strip reader, an optical scanner with character recognition, an RFID reader, etc. The data read by the data reader 92 is communicated to the control module 18 using a connection 94. The first and second seat rails 36, 38 include connections 96 to the control module 18. Connections 94, 96 may be wired or wireless and use any transmission media and access method known now and in the future. Additionally, the connection 94 may be through a computing device of any form factor including a laptop, desktop, personal digital assistant, etc. Memory technologies include, but are not limited to, random access memory, read only memory, flash memory, etc.

With reference to FIG. 7, an initialization process for the initialization system 89 is shown. The data 90 that includes the calibration datum is read from the seat 30 using a data reader 92 and communicated to the control module 18. In an operation 100, the control module 18 receives the data. In an operation 102, the received data is processed to identify the calibration datum. In an operation 104, a validity check of the processed data is performed. For example, in an exemplary embodiment, a comparison is made between a serial number received from the seat rails 36, 38 and a serial number identified from the processed data. Other or additional validity checks may be performed as known to those skilled in the art. In an operation 106, the determination of the data validity is made. If the data is not valid, i.e., the serial numbers do not match, processing continues at operation 104. If the data is valid, i.e., the serial numbers match, the calibration datum is stored in the memory 70.

After initialization, the weight and/or position of the seat occupant can be determined and the occupant classified into one of various occupant classes, e.g., adult, child, infant, close to airbag deployment area, far from airbag deployment area, etc. Vehicle restraint systems can be controlled based on the classification assigned to the occupant. For example, if the classification indicates that an adult is in the seat 30 then the airbag 20a, 20b may be deployed in a normal manner. If the classification indicates that a child or infant is the seat occupant then the airbag 20a, 20b may not be deployed or may be deployed with a lower deployment force.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. For example, the seats used in different vehicles may require different sensor mounting configurations that include a different number of sensors, different sensor locations, different types of sensors, etc. Additionally, the load sensors may comprise a force sensitive resistive element, a membrane switch element, a pressure sensitive resistive contact, a pressure pattern sensor, a strain gauge, a bend sensor, a hydrostatic weight sensing element, etc. operatively coupled to one or more seating surface in the seat bottom and/or seat back. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A system for initializing a module, wherein multiple components associated with the module are assembled separately, the system comprising:
a sensor mounted on an item;
a datum mounted on the item, wherein the datum is associated with the sensor and is captured on the item in the form of a machine-readable code;
a data reader that reads the datum; and
a memory that stores the datum read by the data reader;
wherein the stored datum is used in a module of a product that includes the item.

2. The system of claim 1, wherein the product is a vehicle.

3. The system of claim 2, wherein the item is a seat.

4. The system of claim 3, wherein the module calculates a weight of an occupant of the seat.

5. The system of claim 4, wherein the stored datum is selected from the group consisting of an offset correction for the sensor, a sensitivity calibration for the sensor, and a serial number.

6. The system of claim 5, wherein the offset correction is selected from the group consisting of an offset voltage, an offset weight, and an offset load.

7. The system of claim 6, wherein the offset correction is calculated by performing a zero weight offset test.

8. The system of claim 1, further comprising the module, wherein the module verifies the received datum.

9. The system of claim 8, wherein the received datum comprises a first number related to the item, and further wherein verifying the received datum comprises comparing the first number to a second number received from the sensor.

10. The system of claim 1, wherein the data reader is selected from the group consisting of a bar code reader, a magnetic strip reader, a radio frequency identification reader, and an optical reader.

11. The system of claim 1, wherein the sensor is selected from the group consisting of a force sensitive resistive element, a membrane switch element, a pressure sensitive resistive contact, a pressure pattern sensor, a strain gauge, a bend sensor, and a hydrostatic weight sensing element.

12. A method of initializing an occupant classification module, the method comprising:
receiving a datum from a data reader, wherein the datum is read from a location on an item and is associated with a sensor mounted on the item; and
storing the received datum in a memory;
wherein the stored datum is used in a module of a product that includes the item.

13. The method of claim 12, wherein the product is a vehicle.

14. The method of claim 13, wherein the item is a seat.

15. The method of claim 14, wherein the module calculates a weight of an occupant of the seat.

16. The method of claim 15, wherein the stored datum is selected from the group consisting of an offset correction for the sensor, a sensitivity calibration for the sensor, and a serial number.

17. The method of claim 16, wherein the offset correction is selected from the group consisting of an offset voltage, an offset weight, and an offset load.

18. The method of claim 16, wherein the offset correction is calculated by performing a zero weight offset test.

19. The method of claim 12, wherein the data reader is selected from the group consisting of a bar code reader, a magnetic strip reader, a radio frequency identification reader, and an optical reader.

20. The method of claim 12, wherein the sensor is selected from the group consisting of a force sensitive resistive element, a membrane switch element, a pressure sensitive resistive contact, a pressure pattern sensor, a strain gauge, a bend sensor, and a hydrostatic weight sensing element.
